(19) United States
(12) Patent Application Publication
(10) Pub. No.: US 2024/0402806 A1
(43) Pub. Date: Dec. 5, 2024

(54) Intraocular Brainwave Communicator

(71) Applicant: Ceyeber Corp., Newport Beach, CA (US)

(72) Inventor: Robert Edward Grant, Laguna Beach, CA (US)

(21) Appl. No.: 18/205,113

(22) Filed: Jun. 2, 2023

(51) Int. Cl. G06F 3/01; H04N 23/60

(52) U.S. Cl. CPC G06F 3/015

(57) ABSTRACT

A system that includes an intraocular camera and a neural emissions detecting component that can initiate and then stop a passive persistent broadcast of video captured by the camera based on a neural emission associated with a stimulus or feeling by the user. The system determines a neural emission signature based on the received neural emission signal and determines whether a stop threshold has been met. If the stop threshold has been met, the system causes the camera to stop capturing video, thus avoiding the capture and broadcast of an undesirable situation and preserving the user's privacy along with the privacy of those in the vicinity.

### FIELD OF THE INVENTION

The field of the invention is intraocular camera systems.

### BACKGROUND

The background description includes information that may be useful in understanding the present invention. It is not an admission that any of the information provided herein is prior art or relevant to the presently claimed invention, or that any publication specifically or implicitly referenced is prior art.

The development of high-speed data communications, increasingly smaller computing devices and cameras, and the rise and propagation of social media have enabled anyone to become a content creator. All it takes is an internet-capable camera and a social media account for a person to stream. This has created a new generation of internet stars that simply broadcast aspects of their lives for consumption by viewers.

The popularity of a streamer can depend on their ability to broadcast nearly any aspect of their life from nearly anywhere. Their fans want to see what their lives are really like. As cameras become smaller and more wearable, a streamer can unobtrusively capture more and more moments of their life. The more conspicuous the camera, the more likely a steamer (or people in their environment) is to simply forget that the camera is there. This can lead to more “raw” and “real” moments captured for their stream.

Ocular implants that include cameras can open up a new dimension for a content creator. Having a camera implanted in the eye can open up new possibilities for a streamer and can allow for truly persistent passive broadcasting—where the streamer can truly forget the camera is there and capturing images and thus “passively” broadcasts their life to their fans.

Unfortunately, the hidden nature of an intra-ocular camera can create problems that prior camera systems did not. Because the camera is so hidden, a person in the user's environment may not be able to tell that they are being captured on video-they may not be able to tell there is even a camera present. This can create potential privacy issues if the user were to walk into a restroom or a gym locker room, for example.

Additionally, the passively persistent nature of the recording combined with the implanted camera could cause a user to forget that the camera is even there or that it is recording. This could lead the user to accidentally capture events they do not wish to capture such as private moments in the bathroom or while bathing, during intimate moments, or potentially traumatic or embarrassing moments.

Thus, there is still a need for a passively persistent system that safeguards against unwanted video capture.

### SUMMARY OF THE INVENTION

The inventive subject matter provides apparatus, systems and methods in which an intraocular system includes a camera implanted in an eye of the user and a data transmission interface such that when the camera is activated it can passively and persistently capture video image data and transmit it via the data transmission interface such that the user's day-to-day is broadcast as a passively persistent broadcast.

The system also includes at least one neuronal emissions detector or a physiological sensor disposed on or implanted within the user's body, that can detect a neuronal signal or other physiological response.

The system includes a processor that monitors the detected neuronal signals and determines whether the detected neuronal signal meets a stop threshold. If the stop threshold is met, the processor sends an instruction to the camera to stop capturing video data.

The neuronal signals that are monitored can be those associated with a fear response, a stress response, a humiliation response, a biological need response, and/or based on a release of a particular hormone (e.g., cortisol, adrenaline, etc.).

After issuing the command for the camera to stop, the processor continues processing the detected neuronal signals. If the neuronal signals change such that they no longer meet the threshold, the processor sends a command to the camera to resume capturing video and transmitting it via the data transmission interface.

In embodiments of the inventive subject matter, the system can also obtain location information (e.g., from an on-board or external location interface such as a GPS radio) and the processor determines whether to stop the video capture by the camera based on threshold being met and also on the location.

In embodiments of the inventive subject matter, the processor is programmed to perform image recognition on image data from the captured video data to determine whether it can recognize any objects from a list of objects it “knows” about. Based on a recognition of an object in the image data and the stop threshold being met, the processor causes the camera to stop capturing video.

Various objects, features, aspects and advantages of the inventive subject matter will become more apparent from the following detailed description of preferred embodiments, along with the accompanying drawing figures in which like numerals represent like components.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

The following description includes information that may be useful in understanding the present invention. It is not an admission that any of the information provided herein is prior art or relevant to the presently claimed invention, or that any publication specifically or implicitly referenced is prior art.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a.” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

### BRIEF DESCRIPTION OF THE DRAWING

FIG. 1 provides a diagrammatic overview of a system according to embodiments of the inventive subject matter.

FIG. 2 shows a box-diagram of some of the components of intraocular component within the system, according to embodiments of the inventive subject matter.

FIG. 3 provides a flowchart of the execution of processes, according to embodiments of the inventive subject matter.

FIG. 4 is a detailed breakdown of step 340 of FIG. 3, according to embodiments of the inventive subject matter.

### DETAILED DESCRIPTION

Throughout the following discussion, numerous references will be made regarding servers, services, interfaces, engines, modules, clients, peers, portals, platforms, or other systems formed from computing devices. It should be appreciated that the use of such terms, is deemed to represent one or more computing devices having at least one processor (e.g., ASIC, FPGA, DSP, x86, ARM, ColdFire, GPU, multi-core processors, etc.) programmed to execute software instructions stored on a computer readable tangible, non-transitory medium (e.g., hard drive, solid state drive, RAM, flash, ROM, etc.). For example, a server can include one or more computers operating as a web server, database server, or other type of computer server in a manner to fulfill described roles, responsibilities, or functions. One should further appreciate the disclosed computer-based algorithms, processes, methods, or other types of instruction sets can be embodied as a computer program product comprising a non-transitory, tangible computer readable media storing the instructions that cause a processor to execute the disclosed steps. The various servers, systems, databases, or interfaces can exchange data using standardized protocols or algorithms, possibly based on HTTP, HTTPS, AES, public-private key exchanges, web service APIs, known financial transaction protocols, or other electronic information exchanging methods. Data exchanges can be conducted over a packet-switched network, the Internet, LAN, WAN, VPN, or other type of packet switched network.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

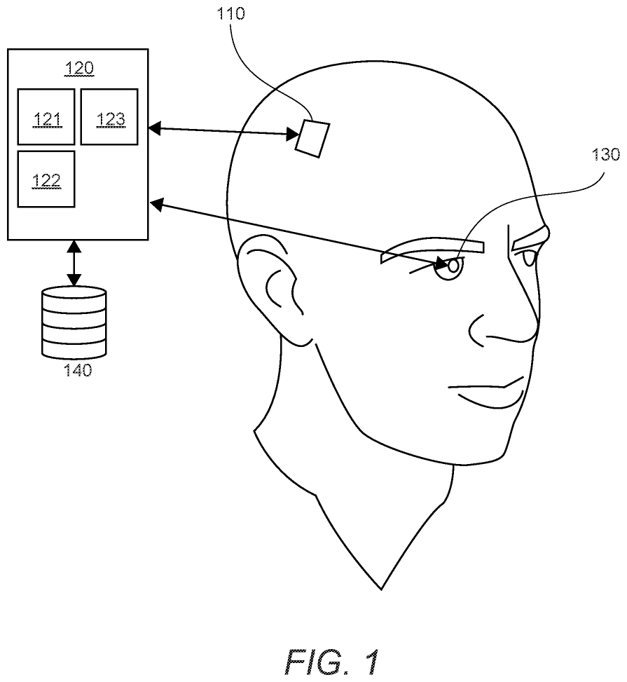

FIG. 1 provides a diagrammatic overview of a system 100 according to embodiments of the inventive subject matter.

As seen in FIG. 1, the system 100 includes a detecting electronic component 110, an analytics electronics component 120 and an intraocular component 130.

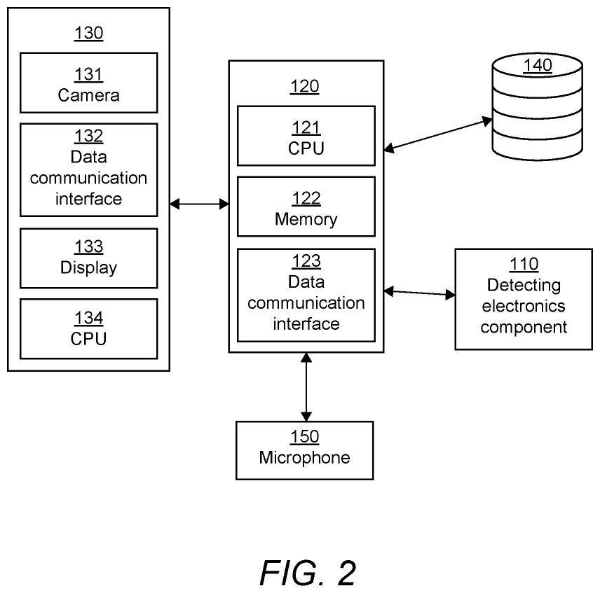

FIG. 2 shows a box-diagram of some of the components of intraocular component 130 within the system 100. The intraocular component 130 is an implantable device that is implanted within the eye of the user. The intraocular component 130 includes an image sensor 131 (e.g., a camera) and a data communications interface 132 (e.g., WiFi, cellular, NFC, Bluetooth, etc.). Examples of suitable intraocular components 130 are described in Applicant's own U.S. Pat. No. 11,353,960, incorporated by reference in its entirety. The system 100 can also include an audio sensor 150 (e.g., a microphone) to pick up sounds from the environment.

In embodiments of the inventive subject matter, the intraocular component 130 can include a display 133 that allows for the presentation of information to the user.

In some embodiments, the intraocular component 130 can include a processor 134 for local processing.

The detecting electronics component 110 is a hardware component that includes a sensor capable of detecting neuronal emissions. Neuronal emissions are detectable signals (e.g., neural oscillations, or brainwaves) emitted from neuronal activity in the brain of the user. As used herein, the terms “neuronal emissions”, “neuronal oscillations” or “brainwaves” include, but are not limited to, waves typically grouped according to predominant frequencies, Delta (0.5 TO 3 Hz), Theta (3 TO 8 HZ), Alpha (8 TO 12 HZ), Beta (12 TO 38 HZ), or Gamma (38 TO 42 HZ) waves.

Conditions other than drowsiness can also be detected using brainwaves. For example, brainwaves can be used to detect dizziness and nausea (“Electroencephalogram (EEG), Mayfield Clinic, April 2018”), as well as migraine-auras (“Your brain with a migraine effect of electric currents, ScienceDaily, Jun. 27, 2018”). Brainwaves can even be used to detect physical motions of a person (Emotion classification based on brain wave: a survey, Li et al., Hum. Cent. Comput. Inf. Sci., 2019″). Still further, brainwaves can be used to detect aura of epilepsy (Dan Z. Milikovsky et al, “Electrocorticographic Dynamics as a Novel Biomarker in Five Models of Epileptogenesis”, The Journal of Neuroscience, 2017; 37 (17): 4450 DOI: 10.1523/JNEUROSCI.2446-16.2017).

The detecting electronics component 110 includes a data exchange interface that enables it to be communicatively coupled with the analytics electronics component 120, such that the detecting electronics component 110 can transmit neural emissions signals to the analytics electronics component 120. The data exchange interface can be one or more wireless and/or wired data exchange interfaces.

In embodiments of the inventive subject matter, the detecting electronics component 110 is a cranial implant positioned in the head of the user. As used herein, the term “cranial implant” means a sensor positioned somewhere on the head of a person. Cranial implants can be located supra- or sub-dermal, or within the cranium, or extend across one or more of those domains.

Some of the critical components are known in the prior art, but not for the claimed methods. US 2018/0153429A1 to Hua describes cranial implants that can be used to monitor brainwaves, including those associated with epilepsy. Applicant's own application published as US 2022/0167923A1 to Grant discusses cranial implants where signals can be interpreted for the purposes of rendering images. US 2018/0153429A1 and US 2022/0167923A1 are incorporated by reference in their entirety.

In embodiments of the inventive subject matter, the detecting electronics component 110 can be implanted within the eye of the user as a part of or separate from the intraocular component 130.

In embodiments of the inventive subject matter, the detecting electronics component 110 is an implanted sensor that is positioned over a portion of the spine of the person.

In embodiments, the detecting electronics component 110 is an implanted sensor positioned over a portion of the peripheral nervous system of the user.

The analytics electronics component 120 includes a processor 121 that enable it to carry out its associated processes and a non-transitory computer readable storage medium 122 (e.g., hard drive, RAM, etc.) that store the processor-executable instructions associated with the processes of the inventive subject matter. The analytics electronics component 120 also includes data communication interfaces 123 such that it is capable of exchanging data with other system components and other computing devices. The data communication interfaces are preferably wireless communication interfaces (e.g., Wi-Fi, cellular, NFC, Bluetooth, or other wireless protocol). However, in certain embodiments where the analytics electronics component 120 is in close proximity to the detecting electronics component 110 and/or intraocular component 130, it is contemplated that the data communication can be wired or otherwise physically coupled (e.g., embodiments where one or more of the components 110, 120, 130 are within the same device). As such, the analytics electronics component 120 is communicatively coupled with the detecting electronics component 110 and the intraocular component 130 such that it can receive data communications from the detecting electronics component 110 and from the intraocular component 130, and transmit data communications back to the intraocular component 130 as discussed herein.

In embodiments of the inventive subject matter, the analytics electronics component 120 is implanted in the body of the user. In variations of these embodiments of the inventive subject matter, the analytics electronics component 120 and the intraocular component 130 can be a single unit.

In other embodiments of the inventive subject matter, the analytics electronics component 120 is a computing device external to the user's body. In these embodiments, the analytics electronic component 120 includes a wireless communication interface sufficiently powerful to be able to communicate with the detecting electronics component 110 and the intraocular component 130. In some of these embodiments, the analytics electronics component 120 can be integrated into a mobile computing device such as a cellular phone of the user, wherein the instructions to execute the processes discussed herein are installed as an application that utilizes the communications capabilities and processing capabilities of the mobile device to execute the processes discussed herein.

The intraocular component 130 is a hardware component that can be implanted into the eye of the user. The intraocular component 130 can include a display 133 that can display an image or other information within the eye such it is visible to the user.

U.S. Pat. Nos. 9,662,199 and 10,299,912, both to Robert Grant, describe an intra-optic lens having electronics for receiving and transmitting data, a digital display, a processor, memory, and an inductively charged power source. US patent application 2017/0075414, also to Grant, describes an implantable/wearable device for detecting diverse anatomical/physiological data. WO 2006/015315 to Feldon describes a digital display positioned on an intraocular lens. US 2013/0194540 to Pugh describes antennas and antenna systems configured into ophthalmic devices, including contact lenses. US 2010/0234942A1 (Peyman) describes intraocular lenses having pigment that can be adjusted automatically by the intensity of the external light, or by electrical stimulation. U.S. Pat. No. 7,001,427 to Aharoni, et al also discusses an intraocular display. All of these references are incorporated by reference in their entirety.

In one or more of the detecting electronics component 110, analytics electronics component 120 and intraocular component 130 includes a battery that powers the corresponding electronics component. One example of a suitable powering component is discussed in U.S. Pat. No. 10,144,707 to Russo, et al, incorporated by reference in its entirety. Other known methods for powering implanted devices can also be used.

As seen in FIG. 1, the system 100 also includes a database 140. The database 140 stores a collection of a neural emission signature patterns. A neural emission signature can be a pattern reflecting a neural emission emitted by a person's brain (e.g., the user) in response to a particular stimulus or body condition. The neural emission signature is the pattern associated with a known condition, against which future neural emissions will be compared to determine what emotions, physical conditions or other state the user is experiencing.

For example, a neural emission signature can reflect the neural emission emitted by the user's brain corresponding to fear.

In another example, a neural emission signature can reflect the neural emission emitted by the user's brain corresponding to embarrassment or humiliation.

In another example, a neural emission signature can reflect the neural emission emitted by the user's brain corresponding to anger.

In another example, a neural emission signature can reflect the neural emission emitted by the user's brain corresponding to a biological function such as an urge to go to the bathroom to relieve the body of waste.

In another example, a neural emission signature can reflect the neural emission emitted by the user's brain corresponding to sexual arousal.

In embodiments, a neural emission signature for a user can be created by sensing detecting, via the detecting electronic component 110, neural emissions of the user. As the user feels different things (e.g., fear, anger, natural urges to go to the bathroom, arousal, etc.), the user can make a note of these feelings via a computing device. The system 100, via the computing device, can transmit to the analytics electronics component 120 a time that the feeling occurred. The system 100, via the analytics electronics component 120, then associates that neural emission patterns with the identified feeling. The patterns associated with these neural emissions are then saved by the system 100 in the database 140 as the neural emission signature for that feeling and an association between the neural emission signature and the feeling is created in the database 140. Thus, in these embodiments, the neural emission signatures are reflective of the user's feelings as reflected by the neural activity.

In embodiments, neural emission signatures can be created based on a collection of neural emissions from a collection of users that have been established, such as using the method discussed above, as corresponding to the different feelings or emotions that are reflected by the signatures. These collected neural emission signatures can be used as a baseline for a given user and adjusted through feedback loops whereby the analytics electronics component 120 can, through pattern recognition, recognize a user's neural patterns as reflecting a particular state or emotion based on the detected neural pattern's similarity to the baselines.

Each neural emission signature stored in the database 140 also includes a stop threshold level or stop threshold value for each neural emission, that is based on an intensity or magnitude of a particular neural emission pattern that is reflected in a neural emissions signature representing a state or feeling in the user where the user is or will likely enter a situation that should not be captured by the camera. As discussed in greater detail below, the stop threshold is a level for a user's emission signals that causes the system to stop capturing video data using the camera 131.

The threshold value can be set based on a collection of users' threshold values for a particular emotion and/or can be set based on a user reporting a feeling that was sufficiently strong that they would not want that situation broadcast.

For example, while a small amount of anger may be reflective of living normal life, a user may not want to have a situation broadcast where they user is at such an anger level that they are not of a rational mind. The threshold value for the neural emissions signature corresponds to the level of anger that a user does not want to have broadcast.

In another example, the threshold value for a neural emissions signature associated with having to go to the bathroom can be one where the user is compelled to actually go to use the bathroom.

In still another example, the threshold value for a neural emissions signature associated with sexual arousal can be one reflecting a situation where a user is about to or expecting to engage in intimate activities.

In embodiments of the inventive subject matter, the detecting electronics component 110 can be disposed within a user to detect neural emissions or other signal from specific parts of the brain. For example, the detecting electronics components 110 can be configured to detect neuronal emissions signals from the amygdala.

In embodiments of the inventive subject matter, additional physiological sensors can be disposed within the body capable of detecting an increased presence of a hormone in the body. For example, a sensor that is configured to detect a spike in adrenaline or cortisol in response to a fear or stress felt by the mind or the body.

As seen in FIG. 2, the system 100 can also include an audio sensor such as a microphone 150. The microphone 150 is generally worn or carried by the user such that it records audio to broadcast along with the video stream captured by camera 131. The microphone 150 can be integral to the analytics electronics component 120, the intraocular implant 130, or can be a separate device that can be worn on the user's clothing, integrated into a pair of eyeglasses, implanted or otherwise attached to the user's skin, etc.

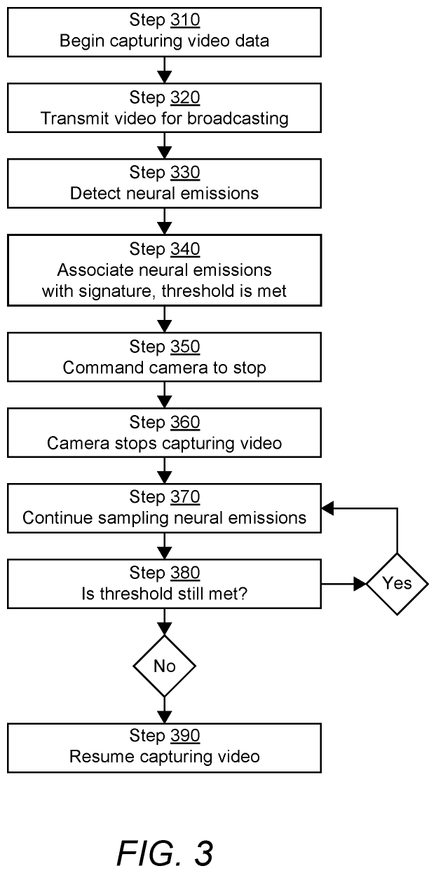

FIG. 3 provides a flowchart of the execution of processes, according to embodiments of the inventive subject matter.

At step 310, the camera 131 begins to capture image data. In the embodiments discussed herein, the image data comprises video data which can, but is not required to, include audio data. For persistent passive broadcasting, the camera 131 captures image data continuously after being initiated.

At step 320, the camera 131 can, via data transmission interface 132, transmit the captured image data to a computing device where it is broadcast out via a livestreaming or broadcasting platform, service or website. Viewers can, via their own computing devices, watch the broadcast by accessing the livestreaming/broadcasting platform/service/website.

At step 330, the detecting electronics component 110 detects neuronal emissions from the user and transmits the neural emissions signals to the analytics electronic component 120. It should be appreciated that the detecting electronics component 110 can, in embodiments, be continuously detecting neuronal emissions and transmitting those to the analytics component 120. As such, the detecting electronics component 110 can transmit discrete, separate transmissions of neural emissions signals and/or continuous streams of neural emissions signals to the analytics electronic component 120.

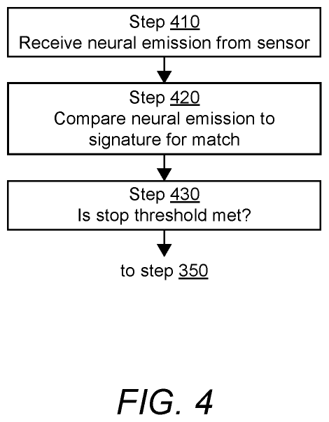

At step 340, the analytics electronic component 120 receives the neural emissions signals and associates the neural emission signals with one or more neural emissions signatures. The process of step 340 is illustrated in greater detail in FIG. 4.

As seen in FIG. 4, the analytics electronic component 120 receives the neural emissions signals from the detecting electronics component 110 at step 410.

At step 420, the analytics electronics component 120 compares the received neural emissions signals to stored neural emission signature patterns to find a match. The match can be done based on comparisons of the emissions signals against the stored neural emission signatures based on cluster recognition or other pattern-recognizing algorithms. Upon finding a neural emission signature pattern that is a sufficiently close match (e.g., within a certain predetermined confidence level), the process proceeds to step 430.

For example, if a user has to go to the bathroom, the neural emissions associated with this sensation will be detected by the detecting electronics component 110 at step 310 and the analytics electronics component 120 associates the neural signals with the neural emissions signature of “having to go to the bathroom” via the matching of step 420.

At step 430, the analytics electronics component 120 then determines whether the received neural emissions signals meet the stop threshold value/level for the identified signature. As discussed above, the stop threshold is a threshold that is reflective of an intensity or level of feeling that is sufficiently high where the recording of the camera 131 has to be stopped to avoid capturing an undesirable situation in the video stream.

The determination of whether detected neural emission(s) meet the stop threshold value can be based on an intensity of the detected neural emission against a threshold intensity level of the neural emission signature for that feeling.

For example, the threshold intensity for the neural emissions signature associated with an urge to go to the bathroom can be a level where a user (either from the user's own historical data, from a collection of data from other users, or a combination of both) actually searches for and goes to use the bathroom.

If the analytics electronics component 120 determines that the threshold value has been met, the process proceeds to step 350 of FIG. 2 where the analytics electronics component 120 sends a command to camera 131 to stop capturing video.

At step 360, the camera 131 ceases to capture video. Thus, continuing with the example above, the persistent passive broadcast by the user of the system is interrupted so that the user does not inadvertently capture video of themselves using the bathroom and also avoids videoing other people in that bathroom, thus preserving everyone's privacy in a sensitive location. If the system includes a microphone 150, the command to stop capture of step 350 also includes a command for the microphone 150 to cease capturing audio data and at step 360 the microphone 150 also stops collecting audio data.

At some point in the future, the reason for the interruption to the video may pass, which would be reflected in the user's neural emission signals. Thus, after step 360, the detecting electronics component 110 continues to sample and detect the user's neural emission signals, and these are continually relayed to the analytics electronics component 120 at step 370.

At step 380, the analytics electronics component 120 repeatedly determines whether the received neural emissions signals continue to meet the stop threshold that was initially met at step 430. If/when the analytics electronics component 120 determines the stop threshold value is no longer met, the analytics electronics component 120 sends a command to camera 131 to begin capturing video image again at step 390.

In embodiments of the inventive subject matter, the determination to stop capturing video can be made based on a combination of meeting the stop threshold and a location. In these embodiments, the system 100 includes a location determination interface such as a GPS device. The GPS device can be integral to the analytics electronic component 120, the intraocular component 130 or on a separate device carried by the user (e.g., a mobile phone).

In these embodiments, the analytics electronic component 120 obtains the location information from the GPS device and determines whether the user is proximate a location designated as prohibited (e.g., locations where capturing video is either expressly prohibited or highly discouraged). A location can be designated as prohibited by distributors of the system or by the user. Examples of such locations can include restrooms, gym locker rooms, certain areas of airports, courtrooms, etc. The user “proximate” to the prohibited location can include the user coming within 50 feet, 20 feet, or even 10 feet of the location.

In some embodiments, this determination of whether a user is proximate to a prohibited location can occur after step 420 (finding a matching neural emissions signature) and can be based on the matched neural emission signature. For example, if the neural emission of the user matched a signature indicative of the user needing to use the bathroom, the analytics electronics component 120 designates bathrooms and gym locker rooms as “prohibited locations” because it is anticipated the user will go to one of these to tend to their needs. This anticipates the possibility that the user will need to go to the bathroom and as such prepares the system if the stop threshold is subsequently met. In a variation of these embodiments, the determination of whether a user is proximate to a prohibited location happens after determining the stop threshold has been met at step 430. In some embodiments, the analytics electronics component 120 is constantly determining whether a user is proximate to any known prohibited location.

Upon determining that the stop threshold has been met and the user is proximate to a prohibited location, the analytics electronics component 120 causes the camera 131 to stop capturing video. This approach prevents a user from capturing video in a prohibited area or location when it is likely that the user will enter this area, but does not interrupt the video stream if the user is likely to be close to but not actually enter a prohibited location.

In further variations of the inventive subject matter, the analytics electronics component 120 is programmed to cause the camera 131 to stop capturing video upon determining that the user has actually entered the prohibited location, regardless of whether or not any stop threshold has been met.

In a variation of these embodiments of the inventive subject matter, certain otherwise “normal” locations only become prohibited based on the identified neural emission signature. For example, if the match of step 420 is that the user is sexually aroused, the analytics electronics component 120 can designate the user's bedroom as a prohibited location. Then the rules regarding a proximity of the user to the prohibited location above would be enforced. In a variation of these embodiments, the designation of an otherwise normal location as a prohibited location is in response to the identified neural emission signature and the stop threshold being met.

In embodiments of the inventive subject matter, the determination to stop capturing video can be made based on a combination of meeting the stop threshold and an identification of an object in the captured video using image recognition techniques.

In these embodiments, the analysis electronics component 120 can perform image recognition on the video data to identify certain objects as indicative of a prohibited location. For example, if the video data shows the user approaching a door that reads “Restroom”, “Bathroom”, “Men” or “Women”, the analysis electronics component 120 recognizes this as pertaining to a restroom. If the user's neural emissions have met a stop threshold for a neural emissions signature associated with a biological need to use the restroom and the analysis electronic component 120 identifies an object associated with a restroom, the analysis electronic component 120 can cause the camera 131 to stop capturing video.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A. B. C . . . and N, the text should be interpreted as requiring only one element from the group, not A plus N. or B plus N, etc.

What is claimed is:

1. An intraocular system for persistent passive broadcasting, comprising:
an intraocular implant comprising a camera;
a data transmission interface;
at least one of a neuronal emissions detector disposed on or within a user's body; and
a processor programmed to:
cause the camera to continually capture video;
transmit, via the data transmission interface, the continually recorded video to at least one remote computer as a video stream; and
in response to a neuronal signal detected by the at least one neuronal emissions detector:
determine that the detected neuronal signal meets a stop threshold; and
cause the camera to stop capturing video in response to meeting the stop threshold.

2. The system of claim 1, wherein the neuronal signal comprises a signal from the user's amygdala.

3. The system of claim 1, wherein the neuronal signal comprises a neuronal signal associated with humiliation.

4. The system of claim 1, wherein the neuronal signal comprises a signal associated with a biological function.

5. The system of claim 1, wherein the signal comprises a neuronal signal associated with a release of a hormone.

6. The system of claim 1, wherein the processor is further programmed to determine a location and the instructions to cause the camera to stop capturing in response to meeting the stop threshold and the determined location.

7. The system of claim 1, wherein the processor is further programmed to:
recognize an object in the captured video;
cause the camera to stop capturing video in response to meeting the stop threshold and the recognized object.

8. The system of claim 1, wherein the processor is further programmed to:
determine that the detected neuronal signal no longer meets the stop threshold; and
cause the camera to resume capturing video.
